(19) United States
(12) Patent Application Publication
(10) Pub. No.: US 2025/0004731 A1
(43) Pub. Date: Jan. 2, 2025

(54) Cross-Component Optimizing Compiler Systems

(71) Applicant: Advanced Micro Devices, Inc., Santa Clara, CA (US)

(72) Inventors: Hashim Sharif, Chatham, IL (US); Johnathan Robert Alsop, Seattle, WA (US)

(73) Assignee: Advanced Micro Devices, Inc., Santa Clara, CA (US)

(21) Appl. No.: 18/214,748

(22) Filed: Jun. 27, 2023

(51) Int. Cl. G06F 8/41

(52) U.S. Cl. CPC G06F 8/443

(57) ABSTRACT

Cross-component optimizing compiler systems are described. In accordance with the described techniques, machine learning models receive components of source code to be compiled. The machine learning models generate component prediction functions for the components of the source code. A tuning engine selects parameters for the components of the source code based on the component prediction functions. Domain-specific language compilers compile the source code based on the selected parameters.

### BACKGROUND

A domain-specific language compiler is capable of translating high-level source code into low-level executable code using domain-specific optimizations. Unlike domain-independent optimizations, which are general-purpose optimizations that are applicable across different domains, the domain-specific optimizations are designed to leverage opportunities for a particular target domain. As a result, executable code compiled using the domain-specific optimizations achieves superior performance for a particular target domain compared to executable code compiled using the domain-independent optimizations.

### BRIEF DESCRIPTION OF THE DRAWINGS

FIG. 1 is a block diagram of a non-limiting example system having a compiler system with machine learning models and a tuning engine.

FIG. 2 is a block diagram of a non-limiting example implementation of the compiler system of FIG. 1 in greater detail.

FIG. 3 is a flow diagram depicting an algorithm as a step-by-step procedure in an example of implementing a cross-component optimizing compiler system.

FIG. 4 is a flow diagram depicting an algorithm as a step-by-step procedure in another example of implementing a cross-component optimizing compiler system.

FIG. 5 is a flow diagram depicting an algorithm as a step-by-step procedure in an example of implementing a tuning engine of a cross-component optimizing compiler system.

### DETAILED DESCRIPTION

### Overview

To leverage domain-specific optimizations, developers have begun using domain-specific language (DSL) compilers to translate source code to executable code, as domain-specific optimizations have been shown to provide multiple factors of improved performance compared to using domain-independent optimizations in conventional compilers. However, existing techniques for DSL compilers result in separately optimized source code components and miss opportunities for co-optimizing different source code components. In the existing compiler landscape, this separate optimization stems from the lack of a multi-domain common intermediate representation (e.g., a platform-independent representation of the source code that can be further processed and optimized before generating the final executable code) that includes the union of existing domain-specific abstractions. Designing such a multi-domain-common intermediate representation is impractical because different DSLs have different (and often conflicting) program abstractions, domain-specific operators, and data structures that are not easily unified in one single intermediate representation abstraction. Even if such a common intermediate representation were to be practical, implementing it would take a significant compiler redesign and development effort.

One existing compiler infrastructure called multi-level intermediate representation (MLIR) supports a hierarchy of intermediate representations with higher-level intermediate representations/dialects and lower-level intermediate representations. While MLIR allows for compiling different DSLs to a common lower-level dialect, it does not include any framework for co-optimizing higher-level domain-specific intermediate representations.

Consider an example scenario of an autonomous navigation system, which includes multiple different application components each performing a subtask in an application pipeline. For instance, autonomous robots used in agriculture and industrial applications include a high-level locomotion controller, components for reading and processing external sensor values, and perception components that use neural networks to predict the robot's current position using camera and sensor inputs. These components have interactions with each other due to an output of one component feeding into the other components as inputs. For instance, the algorithmic choices in the high-level locomotion controller affect an error slack that can be tolerated from neural networks in the perception component, and vice versa. However, existing complier infrastructures, including MLIR, are unable to optimize the algorithmic choices of one component with respect to its effect on another component.

To overcome these problems, cross-component optimizing compiler systems are described. In accordance with the described techniques, a compiler system is provided that co-tunes approximation, algorithmic, data-layout, and hardware selection choices across different application components. By way of example, the compiler system uses a hierarchical tuning approach that learns error and performance prediction functions for individual application components via a local optimizer and uses these prediction functions to perform cross-component global optimization via a global optimizer for end-to-end application-specific quality and performance goals.

For instance, the local optimizer includes machine learning models to generate the error and performance prediction functions for different parameter configurations of individual application components (e.g., different intermediate representations having different approximation, algorithmic, data-layout, and hardware selection choices), and the global optimizer composes these error and prediction functions into a composite prediction function according to a data flow of the application. The data flow of the application defines how outputs of various application components feed into other components as inputs, for example. The global optimizer further includes a tuning engine to automatically explore a search space of the different parameter configurations based on the composite prediction function. The tuning engine is driven with respect to an end-to-end application-specific goal, such as increased accuracy, more efficient performance, and/or reduced energy consumption. By considering the end-to-end application-specific goal, the accuracy of individual components can be relaxed in exchange for better performance, e.g., as calculated via the composite prediction function. Moreover, by performing co-tuning, the optimization choices, approximation choices, algorithmic choices, data layouts, and hardware target selections made for one component by the tuning engine impact the optimization choices for a different component in the application pipeline due to the interrelationship between components, such as in the example autonomous vehicle scenario described above. As a result of using the hierarchical tuning approach, the compiler system described herein efficiently determines parameters for compiling the application components using DSL compilers in a manner that improves the overall application performance. Moreover, the techniques described herein are scalable even to very large applications since different combinations of parameter configurations of the various application components are modeled rather than empirically executed and measured during the cross-component optimization.

In some aspects, the techniques described herein relate to a compiler system including machine learning models to receive components of source code to be compiled and generate component prediction functions for the components of the source code, a tuning engine to select parameters for the components of the source code based on the component prediction functions, and domain-specific language compilers to compile the source code based on the selected parameters.

In some aspects, the techniques described herein relate to a compiler system, wherein the component prediction functions are generated after compiling the components of the source code into intermediate representations.

In some aspects, the techniques described herein relate to a compiler system, wherein the intermediate representations are compiled using the domain-specific language compilers.

In some aspects, the techniques described herein relate to a compiler system, wherein the component prediction functions estimate error and performance for the components of the source code with respect to values of the parameters.

In some aspects, the techniques described herein relate to a compiler system, wherein the parameters include an approximation algorithm, an approximation level, an algorithmic setting, and a hardware configuration.

In some aspects, the techniques described herein relate to a compiler system, wherein the component prediction functions estimate the error for the components of the source code by predicting magnitudes of output errors based on magnitudes of input errors.

In some aspects, the techniques described herein relate to a compiler system, wherein the machine learning models are trained on training data generated by compiling, by the domain-specific language compilers, the components of the source code.

In some aspects, the techniques described herein relate to a compiler system, wherein the training data describe measured error and performance for the components of the source code with respect to different configurations of at least one tunable parameter of an individual component.

In some aspects, the techniques described herein relate to a compiler system, wherein the tuning engine uses error and performance estimates to select values for the parameters with respect to a given objective.

In some aspects, the techniques described herein relate to a compiler system, wherein the objective function defines a performance metric for an application.

In some aspects, the techniques described herein relate to a method including generating, by a local optimizer of a compiler system, a plurality of candidate configurations for individual components of source code, generating, by the local optimizer, per-component prediction functions for the plurality of candidate configurations using machine learning models, selecting, by a global optimizer of the compiler system, configurations for the individual components of the source code based on the per-component prediction functions, and outputting, via domain language-specific compilers of the compiler system, executable code for the individual components of the source code based on the selected configurations.

In some aspects, the techniques described herein relate to a method, wherein each candidate configuration of the plurality of candidate configurations includes at least one different approximation algorithm, approximation level, or hardware configuration from other candidate configurations of the plurality of candidate configurations.

In some aspects, the techniques described herein relate to a method, wherein the plurality of candidate configurations for individual components of the source code includes intermediate representations of respective individual components.

In some aspects, the techniques described herein relate to a method, wherein the intermediate representations of respective individual components are compiled by the domain language-specific compilers.

In some aspects, the techniques described herein relate to a method, wherein the per-component prediction functions estimate an error for respective candidate configurations of the plurality of candidate configurations.

In some aspects, the techniques described herein relate to a method, wherein selecting, by the global optimizer of the compiler system, the configurations for the individual components of the source code based on the per-component prediction functions includes receiving, by the global optimizer, the per-component prediction functions from the machine learning models of the local optimizer, receiving, by the global optimizer, an objective function of an application, composing, by the global optimizer, a composite prediction function based on the per-component prediction functions and a data flow of the individual components of the source code, and selecting the configurations based on the composite prediction function and the objective function.

In some aspects, the techniques described herein relate to a method including generating, by a domain language-specific compiler, configurations of a component of source code, each configuration including a difference in a parameter used for compiling the component, estimating, by machine learning models, a prediction function for each configuration, optimizing, by a tuning engine, the parameter based on the prediction function of each configuration and prediction functions of other components of the source code, and outputting, by the domain language-specific compiler, executable code for the component using the optimized parameter.

In some aspects, the techniques described herein relate to a method, wherein the source code defines an application, and wherein the optimizing, by the tuning engine, is further based on an end-to-end performance objective of the application.

In some aspects, the techniques described herein relate to a method, wherein the optimizing, by the tuning engine, the parameter based on the prediction function of each configuration and the prediction functions of the other components of the source code includes executing, by the tuning engine, a search space strategy to identify a configuration of the component, in combination with other configurations of the other components, that maximizes the end-to-end performance objective of the application.

In some aspects, the techniques described herein relate to a method, wherein the parameter is at least one of an approximation algorithm, an approximation level, or a hardware configuration.

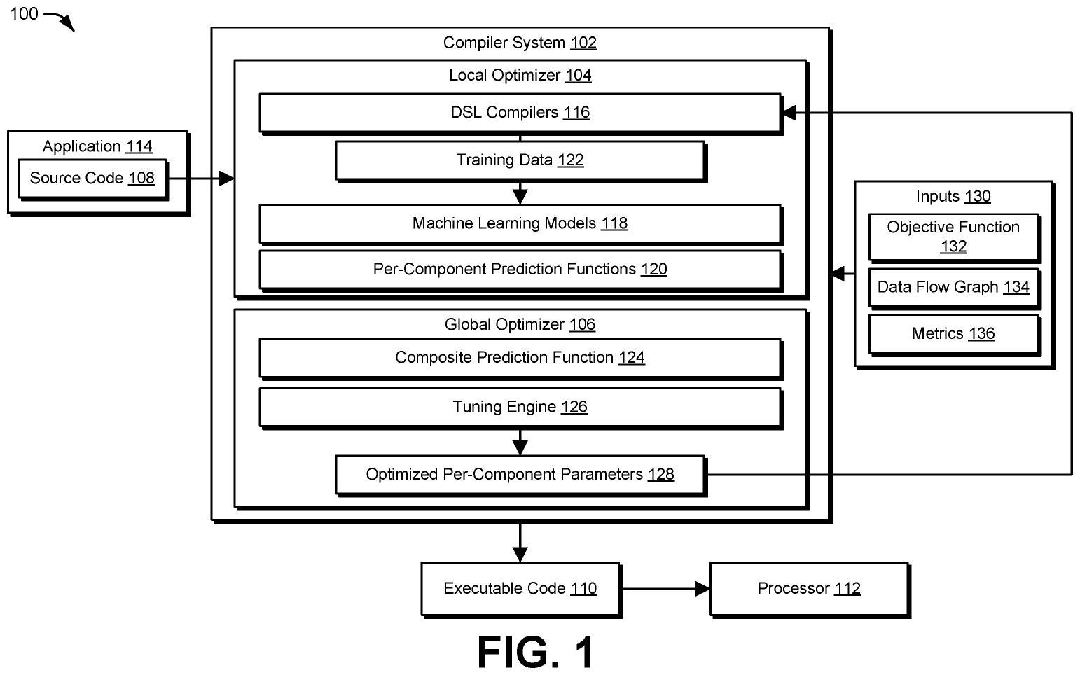

FIG. 1 is a block diagram of a non-limiting example implementation 100 of a compiler system having machine learning models and a tuning engine. The implementation 100 includes a compiler system 102 having a local optimizer 104 and a global optimizer 106, coupled one to another via a wired or wireless connections. Example wired connections include, but are not limited to, buses (e.g., a data bus), interconnects, traces, and planes. The compiler system 102, the local optimizer 104, and the global optimizer 106 are implemented in any of hardware, software, firmware, or a combination thereof. In one or more implementations, the compiler system 102 receives source code 108 and translates the source code 108 into low-level machine code, represented in FIG. 1 as executable code 110, which is executable by at least one processor 112.

The source code 108 corresponds to high-level code of an application 114 that is written in different domain-specific languages. In contrast, in at least one implementation, the executable code 110 is binary code. The executable code 110 is processed, for example, by the at least one processor 112 to run the application 114. Examples of the at least one processor 112 include, but are not limited to, central processing units (CPUs), graphics processing units (GPUs), accelerated processing units (APUs), field programmable gate arrays (FPGAs), digital signal processors (DSPs), neural processing units (NPUs), processing-in-memory (PIM) components having in-memory processors, application specific integrated circuits (ASICs), other integrated circuits (ICs), and so forth.

The source code 108 includes a plurality of components (e.g., application components). With respect to source code 108, a “component” is a block or unit of code for a particular task or subtask of the application 114 that is written in a domain-specific language (DSL). Components of different domain-specific languages, for instance, are compiled by different domain-specific language compilers included in the compiler system 102, represented in FIG. 1 as DSL compilers 116. Notably, the DSL compilers 116 are capable of compiling the components of the source code 110 using domain-specific optimizations.

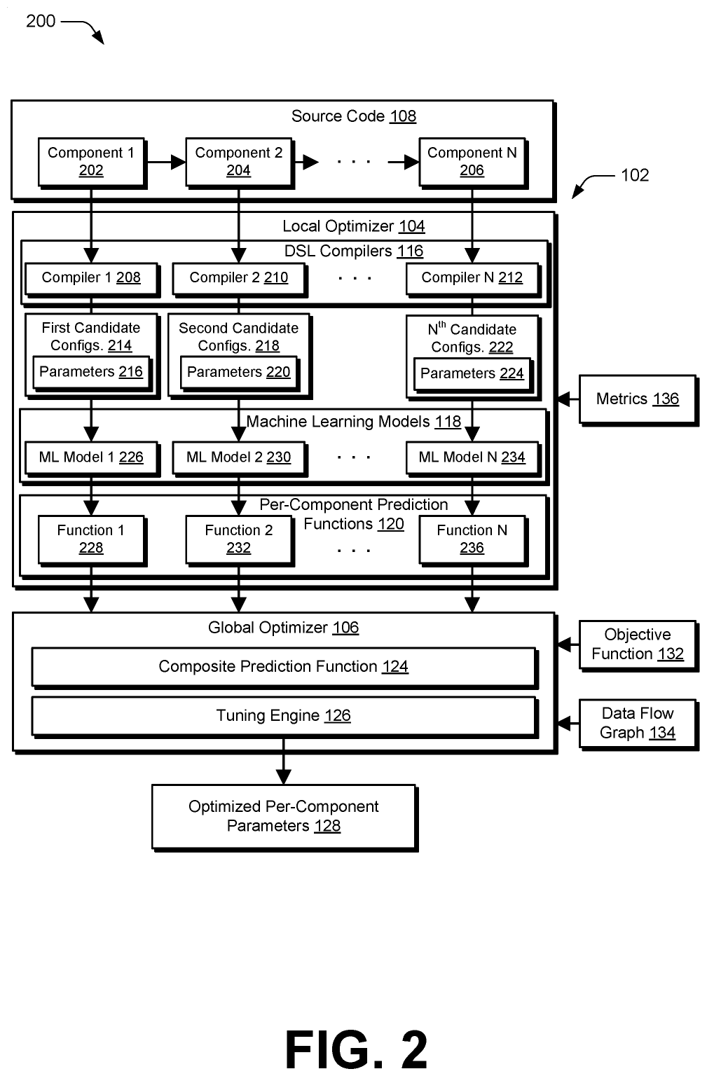

In the present example implementation 100, the local optimizer 104 includes the DSL compilers 116. In at least one implementation, a respective DSL compiler 116 is configured to receive a component of the source code 108 and translate the component into a per-component configuration (also called a “local configuration”) in a domain-specific manner, such as will be elaborated herein, e.g., with respect to FIG. 2. The per-component configuration, for example, is an intermediate representation of one component of the source code 108 (e.g., a lower-level abstraction of the source code) that is generated by the corresponding DSL compiler 116 in a manner that is tailored to a particular domain/application. In at least one implementation, the corresponding DSL compiler 116 applies a set of optimization parameters, approximation parameters, and magnitude of error to generate the per-component configuration. Accordingly, the per-component configuration includes a selection of optimization parameters (e.g., knob values) for operations in the component. Example optimization parameters will be described herein, such as with reference to FIG. 2.

The local optimizer 104 further includes machine learning models 118 and per-component prediction functions 120 that enable the local optimizer 104 to perform the domain-specific optimizations. The machine learning models 118 are trained to evaluate a plurality of candidate per-component configurations to generate the per-component prediction functions 120, which estimate error and performance of the plurality of candidate per-component configurations. For instance, a given component of the source code 108 includes at least one computation, and each candidate configuration of the given component (e.g., the candidate per-component configuration) includes a different approximation technique used for the at least one computation, different parameters used in the approximation technique, and/or a different error magnitude used in the approximation. In this way, the machine learning models 118 are trained to estimate the impact of accuracy-relaxing and accuracy-preserving optimizations on the accuracy and performance of an individual component of the source code 108. Additionally or alternatively, the machine learning models 118 estimate how error propagates through inputs of the component to an output when specific approximation levels (e.g., data precision levels, algorithmic approximations, hardware approximations) and optimization/approximation parameters are applied.

In one or more implementations, the machine learning models 118 are computer representations that are tunable (e.g., trainable) based on inputs to approximate unknown functions. By way of example, the machine learning models 118 include models that utilize algorithms to learn from, and make predictions on, training data 122 by analyzing the training data 122 to learn to generate outputs that reflect patterns and attributes of the known data. According to various implementations, the machine learning models 118 are trainable using supervised learning, semi-supervised learning, unsupervised learning, reinforcement learning, and/or transfer learning. For example, the machine learning models 118 are capable of including, but are not limited to, clustering, decision trees, support vector machines, linear regression, logistic regression, Bayesian networks, random forest learning, dimensionality reduction algorithms, boosting algorithms, transformers, artificial neural networks (e.g., fully-connected neural networks such as a multilayer perceptron, deep convolutional neural networks, or recurrent neural networks), deep learning, autoregressive models, etc. By way of example, the machine learning models 118 perform high-level abstractions in data by generating data-driven predictions or decisions from known input data.

In one or more implementations, the DSL compilers 116 generate the training data 122. By way of example, the local optimizer 104 includes a data and error generator that generates configurations with different combinations of optimization parameters and error assignments, and each configuration is measured for performance and accuracy to generate the training data 122. The data and error generator uses one or a plurality of search strategies, such as random search, greedy search, and/or genetic search, to select the optimization parameters and error assignments of the configurations used in the training data 122.

The global optimizer 106 includes a composite prediction function 124 and a tuning engine 126 that enable the global optimizer 106 to select from the candidate per-component configurations based on the per-component prediction functions 120 to maximize end-to-end performance of the application 114. In at least one implementation, the global optimizer 106 includes functionality that composes the per-component prediction functions 120 into the composite prediction function 124 by combining the per-component prediction functions 120. By way of example, the composite prediction function 124 chains together the per-component prediction functions 120, each invoked with a specific set of optimization parameters selected for that candidate component configuration.

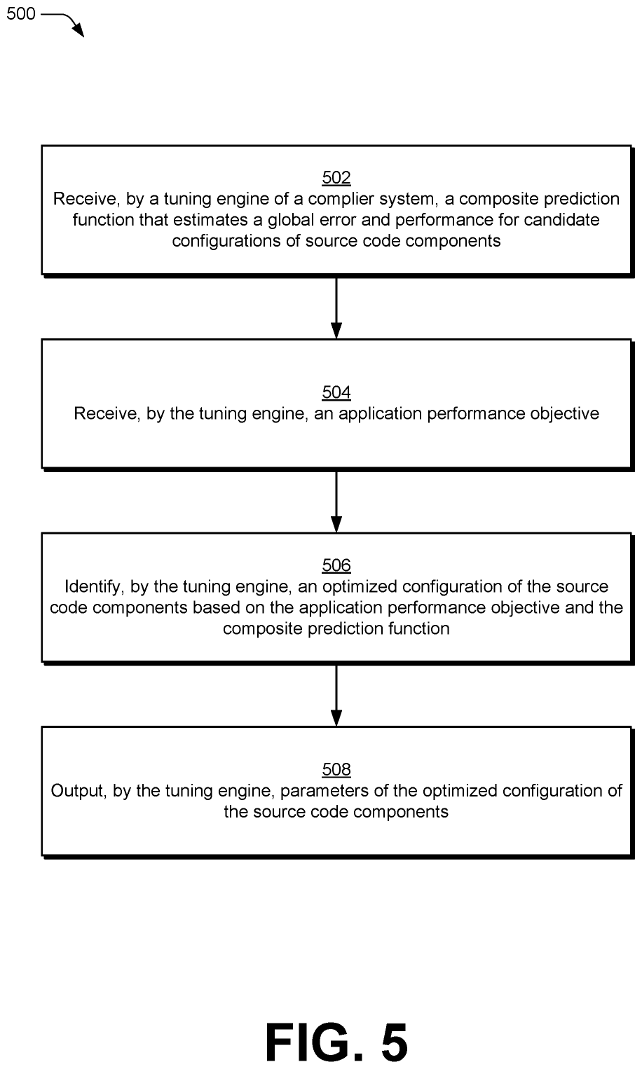

The tuning engine 126 is implemented in any of hardware, software, firmware, or a combination thereof. By way of example, the tuning engine 126 includes instructions for at least one algorithm as well as hardware for executing the at least one algorithm. An example of such an algorithm is described herein with respect to FIG. 5. The tuning engine 126, for instance, includes functionality for selecting optimized per-component parameters 128 of individual components that are used to generate the executable code 110 (e.g., by the DSL compilers 116) in a manner that is configured to maximize the end-to-end performance of the application 114. For example, once the tuning engine 126 selects the optimized per-component parameters 128 for the components of the source code 108, the DSL compilers 116 output the executable code 110 for the respective components using the respective optimized per-component parameters 128. Thus, the executable code 110 is optimized both locally and globally in order to increase end-to-end performance of the application 114 without losing domain-specific abstractions and operations.

For search space exploration of optimization parameters, the tuning engine 126 executes, for example, heuristic search space strategies such as random search, hill climbers, simulated annealing, and genetic search. The search space exploration is driven by information provided via inputs 130. In one or more implementations, a developer provides at least a portion of the inputs 130 to the compiler system 102, such as via command-line inputs, data files, and configuration files. In the illustrated example, the inputs 130 include an objective function 132. The objective function 132, for instance, is an end-to-end application-level optimization objective (or number of objectives) that includes a measurement of how well the application 114 performs its intended goals, such as accuracy, performance, and energy efficiency goals. The objective function 132 is user-configurable, enabling the developer to specify the objective(s), define a constrained optimization objective, and the like. By way of example, a threshold for accuracy is adjustable via the objective function 132.

As a non-limiting, illustrative example where the objective function 132 is to minimize compute time (e.g., maximize performance), exploration techniques used by the tuning engine 126 drive the search toward combinations of component configurations that have lower compute cost and further away from combinations of component configurations with high compute cost. As another illustrative example where the application 114 is for autonomous vehicle operation and the objective function 132 includes decreasing (or minimizing) lane departures, increasing (or maximizing) drive comfort (e.g., less frequent braking and velocity changes), and increasing (or maximizing) fuel efficiency, the search place exploration performed by the tuning engine 126 is driven toward combinations of configurations that decrease lane departures, increase drive comfort, and increase fuel efficiency.

The inputs 130 further include a data flow graph 134. The data flow graph 134 defines a sequential data flow and data dependency of the application 114, such as when an output of one component of the source code 108 is used as an input to another component of the source code 108. In at least one implementation, the data flow graph 134 is determined from the source code 108 itself. Additionally or alternatively, the developer defines the data flow graph 134. The global optimizer 106 utilizes the data flow graph 134 in generating the composite prediction function 124 by, for example, invoking the per-component prediction functions 120 in reverse post order such that the prediction function of a given component is invoked after the prediction functions of predecessor components in the data flow graph 134. This is because the output of a preceding component's prediction function serves as input to prediction functions of successor components.

Consider an illustrative example scenario of the application 114 that includes two different edge detection image filters that run in parallel, with the outputs of each edge detection image filter serving as input to a neural network prediction (NN) component that generates the end-to-end application output. In this example, the quality of the output of the NN component depends also on the quality/accuracy of its inputs from the two predecessor image filter components. Accordingly, as a part of generating the composite prediction function 124, the global optimizer 106 will first compute the accuracy/quality loss of the edge detection image filter components and then use the predicted output errors to feed in as input to the error prediction function of the NN component to predict the end-to-end loss of accuracy/quality. The tuning engine 126 then identifies a combination of configurations for the two different edge detection image filters and the NN component that minimizes the composite prediction function 124 in order to minimize the end-to-end loss of accuracy/quality (e.g., the objective function 132).

The inputs 130 further include metrics 136. The metrics 136 include domain-specific component-level performance and accuracy metrics, for example. In contrast to the objective function 132, which drives end-to-end (e.g., global) optimization, the metrics 136 drive domain-specific, component-level (e.g., local) optimization by the local optimizer 104. For instance, consider an object detection application that includes an image processing component (among other components). In this scenario, an example of the metrics 136 for the image processing component is a peak signal-to-noise ratio, while an example of the objective function 132 of the object detection application is a percentage of correctly detected objects.

In this way, the local optimizer 104 uses the metrics 136 to generate a plurality of locally optimized candidate per-component configurations, and the global optimizer 106 uses the per-component prediction functions 120 of the locally optimized per-component configurations to estimate the performance of the application 114 as a whole in order to generate the optimized per-component parameters 128. Because the exploration of the optimized per-component parameters 128 is performed by the global optimizer 106, the compiler system 102 is able to co-tune the optimization parameters across components in order to increase end-to-end performance and accuracy with respect to the objective function 132. Moreover, the performance predictions of the per-component prediction functions 120 estimated by the machine learning models 118 enable performance and accuracy to be measured without empirically running the application 114 with different combinations of candidate per-component configurations, which saves computing time and processing resources. As such, the compiler system 102 is scalable to larger applications and programs.

FIG. 2 is a block diagram of a non-limiting example implementation 200 of the compiler system 102 of FIG. 1 in greater detail. The implementation 200 depicts the source code 108 as including a first component 202 (e.g., “component 1”), a second component 204 (e.g., “component 2), and an N^{th} component 206 (e.g., “component N”). Ellipses denote that additional components exist between the second component 204 and the N^{th} component 206. By way of example, the first component 202 is the first component in the data flow graph 134, and the N^{th} component 206 is the last component in the data flow graph 134. The DSL compilers 116 include individual compilers for the respective components. In the depicted example, the first component 202 is processed via a first compiler 208 (e.g., “compiler 1”), the second component 204 is processed via a second compiler 210 (e.g., “compiler 2”), and the N^{th} component 206 is processed via an n^{th} compiler 212 (e.g., “compiler N”).

The first compiler 208 processes the first component 202 to generate a plurality of candidate per-component configurations (e.g., intermediate representations) of the first component 202, depicted in FIG. 2 as first candidate configurations 214 (abbreviated as “first candidate configs.”), which include settings for optimization parameters, represented in FIG. 2 as parameters 216. It is to be appreciated that individual configurations of the first candidate configurations 214 include at least one different setting for the parameters 216 with respect to each other. By way of example, an individual configuration of the first candidate configurations 214 includes a unique combination of the parameters 216 with respect to the other configurations of the first candidate configurations 214.

The second compiler 210 processes the second component 204 to generate a plurality of candidate per-configurations (e.g., intermediate representations) of the second component 204, depicted in FIG. 2 as second candidate configurations 218 (abbreviated as “second candidate configs.”), which include optimization parameters, represented in FIG. 2 as parameters 220. Similar to the first candidate configurations 214, individual configurations of the second candidate configurations 218 include at least one different setting for the parameters 220 with respect to each other. Because the second component 204 includes different operations and domain-specific constraints and optimization goals from the first component 202, the parameters 220 include a different set of one or more optimization parameters from the parameters 216, at least in one implementation.

The N^{th} compiler 212 processes the N^{th} component 206 to generate a plurality of candidate per-configurations (e.g., intermediate representations) of the N^{th} component 206, depicted in FIG. 2 as N^{th} candidate configurations 222 (abbreviated as “N^{th} candidate configs.”), which include optimization parameters, represented in FIG. 2 as parameters 224. Similar to the first candidate configurations 214 and the second candidate configurations 218, individual configurations of the N^{th} candidate configurations 222 include at least one different setting for the parameters 224 with respect to each other. Because the N^{th} component 206 includes different operations and domain-specific constraints and optimization goals from the first component 202 and the second component 204, the parameters 224 include a different set of one or more optimization parameters from the parameters 216 and/or the parameters 220, at least in one implementation.

In one or more implementations, the parameters 216, 220, and 224 are selected by the respective DSL compilers 116 based on the metrics 136. Examples of the parameters 216, 220, and 224 include approximation levels (e.g., data precision levels), algorithmic approximations (e.g., replacing an FFT function with a more performant but lower accuracy version), and hardware approximations (e.g., analog computation). The DSL compilers 116 apply these domain-specific optimizations to high-level operations in the respective components of the source code 108. In an example scenario where the component includes codes for implementing a neural network, tensor convolutions followed by tensor add operations are translated by the corresponding DSL compiler to a fused conv-add operation that better exploits data locality. Non-limiting examples of algorithmic approximations include choices of algorithms exposed in the configuration, such as a choice of a video rendering algorithm to use, or number of samples to draw from a distribution of values. Algorithmic choices can attenuate or dampen errors propagated through a given component. For instance, an algorithm that is more tolerant to errors in its inputs will reduce the error propagated through the outputs.

Additionally or alternatively, the parameters 216, 220, and 224 include hardware selections for running the respective component. By way of example, hardware selection affects both local component performance as well as components invoked downstream in a pipeline (e.g., an ordered execution occurrence of the components of the source code 108). For instance, while running the first component 202 on a GPU/accelerator may be the most efficient in terms of local compute time, the cost of moving data may make it less desirable to offload the task to the GPU/accelerator.

When considering an application component in the context of the full application (e.g., the application 114), the inputs to the components include errors due to approximations being applied in the earlier components. By way of example, the input to the second component 204 includes error due to approximations applied to the first component 202, such as the approximations described above. To simulate the effect of approximate inputs feeding into the second component 204, the local optimizer 104 injects varying levels of error into the different inputs. The magnitude of the error is varied in terms of input-specific accuracy metrics of the metrics 136. For instance, for tensor inputs, aggregate metrics (e.g., L-norm metrics) capture the difference of the approximate input (with errors) and the original inputs with no errors. The injected errors are sampled from error distributions that are representative of the available approximation techniques. For instance, for an analog compute accelerator with a Gaussian error model, the error injection includes sampling error values from a Gaussian distribution. The input errors are tailored to each domain/application and different types of input such as tensor, image, vector, command-line inputs. etc. via the respective DSL compilers 116.

The machine learning models 118 receive the candidate per-component configurations from the respective DSL compilers 116 and output the per-component prediction functions 120 based on the metrics 136. In the non-limiting example implementation 200, a first machine learning model 226 (e.g., “ML model 1”) receives, as input, the first candidate configurations 214 and outputs a first prediction function 228 (e.g., “function 1”); a second machine learning model 230 (e.g., “ML model 2”) receives, as input, the second candidate configurations 218 and outputs a second prediction function 232 (e.g., “function 2”); and an N^{h} machine learning model 234 (e.g., “ML model N”) receives, as input, the N^{th} candidate configurations 222 and outputs an N^{th} prediction function 236 (e.g., “function N”).

The global optimizer 106 receives the first prediction function 228, the second prediction function 232, and the N^{th} prediction function 236 (as well as other prediction functions of the per-component prediction functions 120) and generates the composite prediction function 124 based on the data flow graph 134. The tuning engine 126 selects and outputs optimized per-component parameters 128 based on the composite prediction function 124 and the objective function 132, such as described above with respect to FIG. 1.

Although not explicitly shown in FIG. 2 for illustrative clarity, the DSL compilers 116 output the executable code 110 for respective components of the source code 108. By way of example, the first compiler 208 outputs a first portion of the executable code 110 that corresponds to the first component 202 by setting the parameters 216 to the respective optimized per-component parameters 128 for the first component 202, the second compiler 210 outputs a second portion of the executable code 110 that corresponds to the second component 204 by setting the parameters 220 to the respective optimized per-component parameters 128 for the second component 204, and the N^{th} compiler 212 outputs an N^{th} portion of the executable code 110 that corresponds to the N^{th} component 206 by setting the parameters 224 to the respective optimized per-component parameters 128 for the N^{th} component 206.

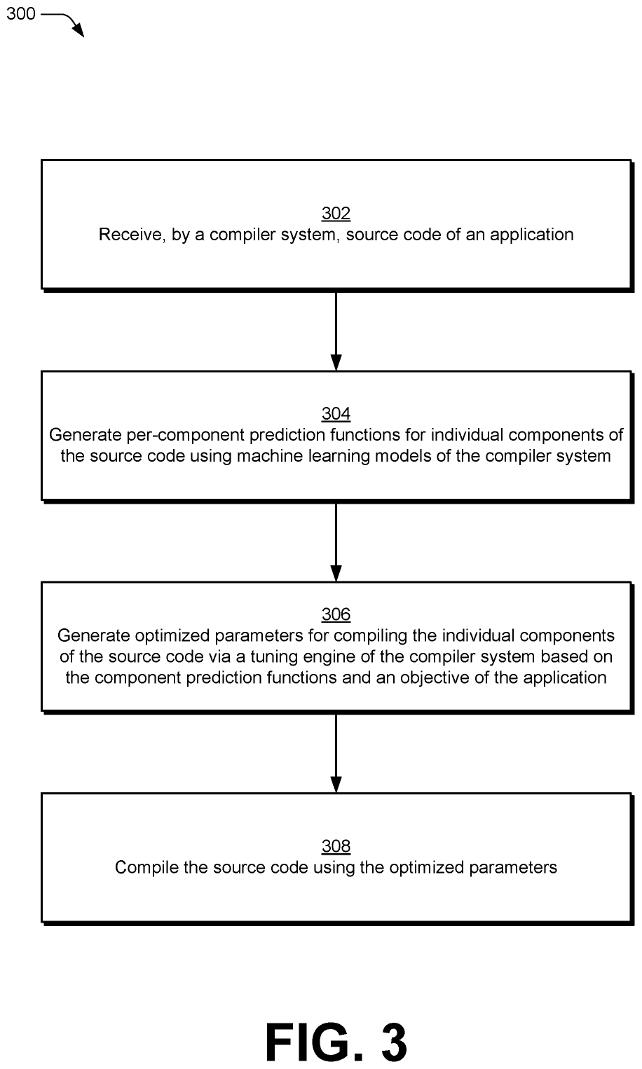

FIG. 3 is a flow diagram depicting an algorithm as a step-by-step procedure 300 in an example of implementing a cross-component optimizing compiler system.

Source code of an application is received by a compiler system (block 302). By way of example, the source code 108 includes a plurality of components, such as the first component 202 and the second component 204, that represent groups of operating tasks or subtasks performed in executing the application 114. The source code 108 is written in various high-level programming languages (e.g., domain-specific languages), and individual components are written in a single domain-specific language.

Per-component prediction functions are generated for individual components of the source code using machine learning models of the compiler system (block 304). By way of example, the per-component prediction functions 120 estimate an error and performance of intermediate representations of the individual components. The intermediate representations, also referred to herein as configurations, are generated from the individual components by the DSL compilers 116 and include one or more different tunable parameters used for compiling the respective component, which are set to respective values. After the components of the source code are compiled into the intermediate representations (e.g., by the DSL compilers 116), the machine learning models 118 estimate the per-component prediction functions 120 so that a plurality of different configurations are assessed without executing the application 114, e.g., by the at least one processor 112 and directly (e.g., empirically) measuring the error and performance.

Optimized parameters for compiling the individual components of the source code are generated via a tuning engine of the compiler system based on the component prediction functions and an objective of the application (block 306). By way of example, the global optimizer 106 composes the per-component prediction functions 120 into the composite prediction function 124 based on the data flow graph 134 so that an output error for a given component is dependent on a magnitude of error for a preceding component, which serves as an input. In at least one implementation, by using the composite prediction function 124, the tuning engine 126 of the global optimizer 106 performs a search of various combinations of the intermediate representations to identify a combination of component configurations that, when used together, optimize (e.g., maximize or minimize) the objective function 132 of the application 114 (e.g., the end-to-end goal, such as maximizing processing efficiency or minimizing energy consumption). The parameters of this combination of configurations are output as the optimized per-component parameters 128, for instance. As such, the optimized per-component parameters 128 are co-tuned with respect to each other by using the composite prediction function 124 and the objective function 132.

The source code is compiled using the optimized parameters (block 308). By way of example, the DSL compilers 116 compile the individual components of the source code 108 into the executable code 110 using the optimized per-component parameters 128 determined by the tuning engine 126. For instance, the executable code 110 is optimized binary code for individual components of the source code 108 that is executable by the at least one processor 112 to run the application 114.

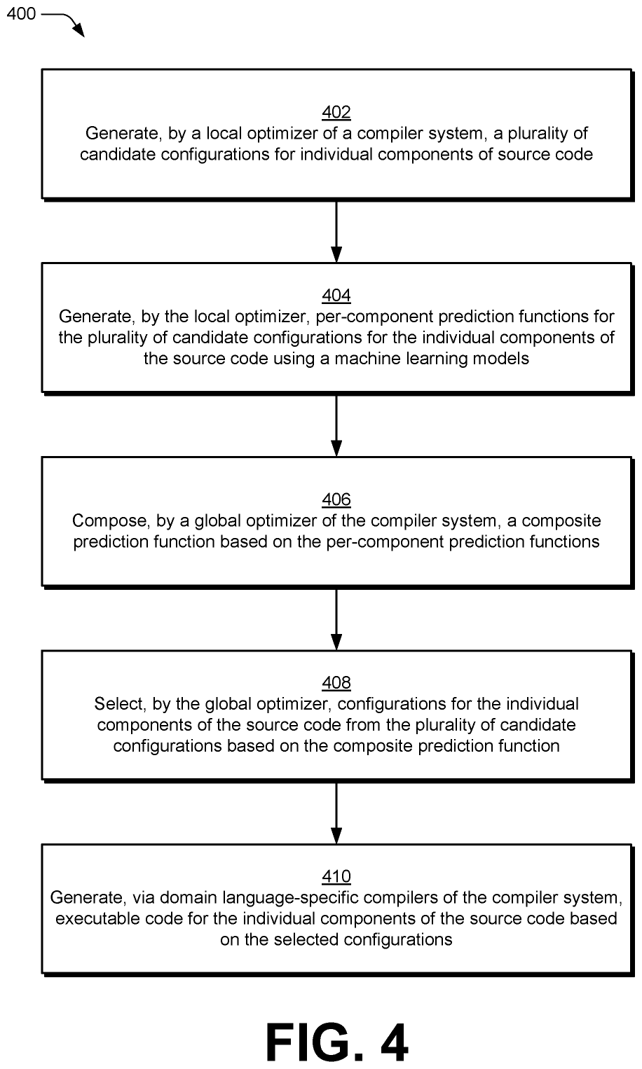

FIG. 4 is a flow diagram depicting an algorithm as a step-by-step procedure 400 in another example of implementing a cross-component optimizing compiler system.

A plurality of candidate configurations for individual components of source code are generated by a local optimizer of a compiler system (block 402). By way of example, the local optimizer 104 generates the plurality of candidate configurations using DSL compilers 116 such that the individual components are compiled into intermediate representations in a domain-specific manner.

Per-component prediction functions for the plurality of candidate configurations for the individual components of the source code are generated by the local optimizer using machine learning models (block 404). By way of example, the machine learning models 118 are trained via training data 122 that include a plurality of configurations of the components of the source code 108, or other source code having other components, and associated performance and error metrics. For instance, the associated performance and error metrics are measured during running the application 114 with the plurality of configurations. In this way, the machine learning models 118 learn how output errors are propagated through the components of the source code based on input errors injected into the components of the source code. This enables the machine learning models 118 to estimate error and performance metrics for the plurality of candidate configurations of the individual components without having to run the application 114 with these candidate configurations.

Estimates of the error and performance metrics of the plurality of candidate configurations are output by the machine learning models 118 as the per-component prediction functions 120. For instance, the machine learning models 118 output a prediction function corresponding to estimated error and performance metrics for each of the plurality of candidate configurations.

A composite prediction function is composed by a global optimizer of the compiler system based on the per-component prediction functions (block 406). By way of example, the global optimizer 106 chains together the per-component prediction functions 120 according to the data flow graph 134, which defines a data dependency direction of the components of the source code 108.

Configurations for the individual components of the source code are selected by the global optimizer from the plurality of candidate configurations based on the composite prediction function (block 408). By way of example, the tuning engine 126 executes heuristic search space strategies (e.g., random search, hill climbers, simulated annealing, and/or genetic search) based on the objective function 132, which defines accuracy, performance, and/or energy efficiency goals of the application 114. In performing the search, the tuning engine 126 evaluates various combinations of the plurality of candidate configurations via the composite prediction function 124 to drive the composite prediction function 124 toward the objective function 132, for instance. This enables the tuning engine 126 to identify a combination of candidate configurations for the components of the source code 108 that achieve the objective function 132, such as by increasing (e.g., maximizing) accuracy, decreasing (e.g., minimizing) energy consumption, and/or improving (e.g., maximizing) performance compared with the other combinations explored. The tuning engine 126 further identifies the parameters associated with the candidate configurations in the combination as the optimized per-component parameters 128.

Executable code for the individual components of the source code is generated via domain language-specific compilers of the compiler system based on the selected configurations (block 410). By way of example, the DSL compilers 116 compile the individual components of the source code using the optimized per-component parameters 128 so that the output executable code 110 is optimized for the objective function 132 of the application 114 as well as leveraging domain-specific optimizations.

It should be understood that many variations are possible based on the disclosure herein. Although features and elements are described above in particular combinations, each feature or element is usable alone without the other features and elements or in various combinations with or without other features and elements.

FIG. 5 is a flow diagram depicting an algorithm as a step-by-step procedure 500 in an example of implementing a tuning engine of a cross-component optimizing compiler system. In one or more implementations, at least a portion of the procedure 500 is executed as a part of the procedure 300 of FIG. 3 (e.g., at block 306) and/or the procedure 400 of FIG. 4 (e.g., at block 408). Alternatively, the procedure 500 is executed separately from the procedure 300 and/or the procedure 400.

A composite prediction function that estimates a global error and performance for candidate configurations of source code components is received by a tuning engine of a complier system (block 502). By way of example, the composite prediction function 124 links together the per-component prediction functions 120, each invoked with a specific set of parameters selected for a candidate per-component configuration (e.g., a candidate configuration of an individual component of the source code 108), according to the data flow graph 134 such that the prediction function of a given component is invoked after the prediction functions of predecessor components in the data flow graph 134.

An application performance objective is received by the tuning engine (block 504). By way of example, the application performance objective includes at least one end-to-end application-level optimization objective with respect to an accuracy, performance, and/or energy efficiency of running the application 114. In one or more implementations, the application performance objective is received by the tuning engine 126 as the objective function 132. In at least one instance, the objective function is received as input from a developer. Alternatively, the objective function 132 is determined by the tuning engine 126, or another component of the compiler system 102, based on instructions in the source code 108.

An optimized configuration of the source code components is identified by the tuning engine based on the application performance objective and the composite prediction function (block 506). By way of example, the optimized configuration of the source code components refers to the combination of candidate per-component configurations that increases (or maximizes) the accuracy, performance, and/or energy efficiency of running the application 114, as specified by the objective function 132. In at least one implementation, the tuning engine 126 includes instructions for one or more search space strategies (e.g., algorithms), the execution of which enables the tuning engine 126 to efficiently explore different combinations of per-component configurations. For example, the application performance objective provides rules and/or constraints that guide the search space strategy to prioritize certain combinations of per-component configurations over others, and the tuning engine 126 estimates error and/or performance values for a given combination of per-component configurations using the composite prediction function 124.

Parameters of the optimized configuration of the source code components are output by the tuning engine (block 508). By way of example, the parameters corresponding to the identified optimized configuration of the source code components are output by the tuning engine 126 so that DSL compilers 116 can compile the components of the source code 108 using these parameters. The parameters include at least one of an approximation algorithm, an approximation level, an algorithmic setting, and a hardware configuration for individual components of the source code. In this way, the components of the source code 108 are optimized with respect to the objective function 132, enabling end-to-end performance increases for the application 114 compared to when the individual components of the source code are not globally optimized.

The various functional units illustrated in the figures and/or described herein (including, where appropriate, the compiler system 102, the local optimizer 104, the global optimizer 106, and the at least one processor 112) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), one or more Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A compiler system comprising:
machine learning models to:
receive components of source code to be compiled; and
generate component prediction functions for the components of the source code;
a tuning engine to select parameters for the components of the source code based on the component prediction functions; and
domain-specific language compilers to compile the source code based on the selected parameters.

2. The compiler system of claim 1, wherein the component prediction functions are generated after compiling the components of the source code into intermediate representations.

3. The compiler system of claim 2, wherein the intermediate representations are compiled using the domain-specific language compilers.

4. The compiler system of claim 1, wherein the component prediction functions estimate error and performance for the components of the source code with respect to values of the parameters.

5. The compiler system of claim 1, wherein the parameters include an approximation algorithm, an approximation level, an algorithmic setting, and a hardware configuration.

6. The compiler system of claim 4, wherein the component prediction functions estimate the error for the components of the source code by predicting magnitudes of output errors based on magnitudes of input errors.

7. The compiler system of claim 1, wherein the machine learning models are trained on training data generated by compiling, by the domain-specific language compilers, the components of the source code.

8. The compiler system of claim 7, wherein the training data describe measured error and performance for the components of the source code with respect to different configurations of at least one tunable parameter of an individual component.

9. The compiler system of claim 1, wherein the tuning engine compiles the source code based on estimated error and performance for the components of the source code with respect to an objective function.

10. The compiler system of claim 9, wherein the objective function defines a performance metric for an application.

11. A method comprising:
generating, by a local optimizer of a compiler system, a plurality of candidate configurations for individual components of source code;
generating, by the local optimizer, per-component prediction functions for the plurality of candidate configurations using machine learning models;
selecting, by a global optimizer of the compiler system, configurations for the individual components of the source code based on the per-component prediction functions; and
outputting, via domain language-specific compilers of the compiler system, executable code for the individual components of the source code based on the selected configurations.

12. The method of claim 11, wherein each candidate configuration of the plurality of candidate configurations includes at least one different approximation algorithm, approximation level, or hardware configuration from other candidate configurations of the plurality of candidate configurations.

13. The method of claim 11, wherein the plurality of candidate configurations for individual components of the source code comprises intermediate representations of respective individual components.

14. The method of claim 13, wherein the intermediate representations of respective individual components are compiled by the domain language-specific compilers.

15. The method of claim 11, wherein the per-component prediction functions estimate an error for respective candidate configurations of the plurality of candidate configurations.

16. The method of claim 11, wherein selecting, by the global optimizer of the compiler system, the configurations for the individual components of the source code based on the per-component prediction functions comprises:
receiving, by the global optimizer, the per-component prediction functions from the machine learning models of the local optimizer;
receiving, by the global optimizer, an objective function of an application;
composing, by the global optimizer; a composite prediction function based on the per-component prediction functions and a data flow of the individual components of the source code; and
selecting the configurations based on the composite prediction function and the objective function.

17. A method comprising:
generating, by a domain language-specific compiler, configurations of a component of source code, each configuration including a difference in a parameter used for compiling the component;
estimating, by machine learning models, a prediction function for each configuration;
optimizing, by a tuning engine, the parameter based on the prediction function of each configuration and prediction functions of other components of the source code; and
outputting, by the domain language-specific compiler, executable code for the component using the optimized parameter.

18. The method of claim 17, wherein the source code defines an application, and wherein the optimizing, by the tuning engine, is further based on an end-to-end performance objective of the application.

19. The method of claim 18, wherein the optimizing, by the tuning engine, the parameter based on the prediction function of each configuration and the prediction functions of the other components of the source code comprises executing, by the tuning engine, a search space strategy to identify a configuration of the component, in combination with other configurations of the other components, that maximizes the end-to-end performance objective of the application.

20. The method of claim 17, wherein the parameter is at least one of an approximation algorithm, an approximation level, or a hardware configuration.
